(19) United States
(12) Patent Application Publication
(10) Pub. No.: US 2014/0136327 A1
(43) Pub. Date: May 15, 2014

(54) METHOD FOR USING SMART PHONE FOR TARGETING POTENTIAL CUSTOMERS

(71) Applicant: Subba Rao Gopavarapu, Irvine, CA (US)

(72) Inventor: Subba Rao Gopavarapu, Irvine, CA (US)

(21) Appl. No.: 14/078,486

(22) Filed: Nov. 12, 2013

Related U.S. Application Data
(60) Provisional application No. 61/725,922, filed on Nov. 13, 2012.

(51) Int. Cl. G06Q 30/02

(52) U.S. Cl. CPC G06Q 30/0261; G06Q 30/0267
USPC 705/14.58

(57) ABSTRACT

An electronic for-sale sign mobile based application is disclosed. The mobile application provides a platform for dynamic linking between users configured with the application to perform mobile commerce. The technology utilizes Global Positioning System tracking and stored cloud databases of available merchandise and services for connecting sellers and potential buyers. The invention is meant for targeted audience and is highly convenient, considering the application requires the use of a mobile device such as a smart phone.

### FIELD OF THE INVENTION

The present invention relates to a method for targeted marketing using location based service and search capability, more particularly, to a mobile application for linking consumers with the suppliers of goods using Global Positioning System (GPS) tracking and stored databases of available merchandise or services.

### BACKGROUND

Since the advent of the internet and the rapid advances in web technology, e-commerce trends for the advertisement of products and services are going through an evolutionary change over the last few years. Free search engines either generic ones (Google, Bing), or for specific products (Amazon), or auction capabilities (eBay), or social networking channels (Facebook) are the dominating trends of sales and marketing initiatives today, as opposed to traditional TV or newspaper advertisements.

With the advent of mobile technology and the proliferation of smart phones, with Apple dominating the mobile market share, and Google with the maximum number of mobile devices deployed with the Android OS, the competition has become intense in the ever growing market of advertising for generating revenue.

Currently Google Ad Words technology captures keywords in Google searches or email traffic, and triggers relevant advertisement. For instance, searching for cars will trigger an advertisement from Auto Trader. Searching for a book will trigger an Amazon advertisement. Typically the success rate or “return on spend” of on-line advertising is measured through six metrics: Click Through Rate, i.e. the percent rate of the number of the times a consumer clicks at an advertisement that was displayed; Average Position, i.e. the page rank of the ad in a Google search; Quality Score, i.e. how well the keyword, landing page and ad relate to a search; Impression Share, i.e. how often the ad shows in relation to the total number of queries associated with the keyword; Bounce Rate, i.e. how fast people leave the ad page without probing further and Conversion Rate, i.e. rate at which the ad converts unique visitors into buyers. (A conversion rate of 1.25% is considered a healthy industry standard).

However, most of these trigger based mechanisms are viewed by the consumers as unwanted spam to be largely ignored. In view of the aforementioned limitation of the existing technology, there is a need for a targeted marketing channel that brings the relevant information to the consumer who needs it the most.

### SUMMARY OF THE INVENTION

In an aspect of the present invention, a method for targeted marketing based on location based information is provided. The present invention provides a mobile application that acts as a mean for quick dynamic linking between highly motivated and interested consumers and the suppliers of merchandise or services, using mobile technology, Global Positioning System and stored databases of available merchandise or services.

An electronic for-sale sign is generated for a product or a physical quantity the seller wishes to sell. The electronic for-sale sign is implemented in a smart phone using the mobile application and the for-sale sign can be configured to advertise the product for sale. The mobile application provides the user of the smart phone to enter preference criteria: whether the user wishes to purchase or to sell the product. The user preference is stored in the smart phone and whenever the user moves from one place to another, the electronic for-sale sign moves with the user. As the user moves around in a geographical area, the mobile device, such as a smart phone, can advertise the electronic for-sale sign to nearby mobile devices that are configured to receive such electronic messages. Only, the mobile user who expresses interest in buying the product being advertised would receive the electronic message.

The advantage associated with the electronic for-sale sign over physical for-sale sign is that the electronic for-sale sign need not be positioned on the item for sale and need not be adhered or affixed to a product that is being sold. Rather the electronic for-sale sign can be positioned or stored in the mobile device.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic representation of a system for location based targeted marketing in accordance with an embodiment of the present invention.

FIG. 2 illustrates a functional architecture of a mobile application used for location based targeted marketing in accordance with an embodiment of the present invention.

FIG. 3 is a flow diagram explaining the process of advertising a product for sale by a user, using the mobile application in accordance with an embodiment of the present invention.

FIG. 4 is a flow diagram illustrating the process of advertising a requirement of a product, using the mobile application in accordance with an embodiment of the present invention.

FIG. 5 is a flow diagram that illustrates the operation for facilitating the match between the buyer and the seller criteria in accordance with an embodiment of the present invention.

FIG. 6 shows a user interface showing the options available for a buyer or a seller in the mobile application in accordance with an embodiment of the present invention.

FIGS. 7A and 7B show a user interface with the product or service description offered by the seller and the payment information in accordance with an embodiment of the present invention.

FIGS. 8A and 8B show a user interface of the mobile application showing the buyer preference criteria and the corresponding search results displayed by the mobile application in accordance with an embodiment of the present invention.

### DETAILED DESCRIPTION OF THE INVENTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a mobile based application for targeted marketing and commerce between interested consumers, buyers, customers, government agencies, and the suppliers of merchandise or services. The mobile application utilizes location sensing technology such as Global Positioning System tracking, transmission system such as Wi-Fi, Bluetooth, radio waves, and stored cloud databases of available merchandise or services present online.

The invention embodies systems and methods that can be configured to generate an electronic for-sale sign. The electronic for-sale design can be implemented in a mobile device for example, a smart phone, using a mobile application. The mobile application, once integrated would provide an interface to the user of the mobile device, to perform mobile commerce, wherein the mobile commerce may comprise, however not limited to, advertising a merchandise/service, searching a merchandise/service, presenting a merchandise/service on an interface, locating a desired match of merchandise/service, buying and/or selling of the merchandise/service.

The electronic for-sale sign is identifiable by the mobile application in other mobile devices. The mobile application identifies other mobile devices that are configured with the electronic for-sale sign, and after identification receives or sends messages in a geographical area. As the user of the electronic for-sale sign moves around in a geographical area, the mobile device of the user can present an advertisement for sale or purchase through the mobile application to the nearby mobile devices that too are configured with the electronic for-sale sign.

Unlike the traditional physical for-sale sign, the electronic for-sale sign need not be positioned on an item for sale. Since the invention is based on the mobile based electronic for-sale sign, the application is highly relevant to most of the consumers, given that the mobile technology is among the fastest growing segments of the market. More so, the consumers would usually spend more time on smart phones and iPads than traditional desktops and laptops while commuting that makes the present invention suitable for consumers who are mostly on the move.

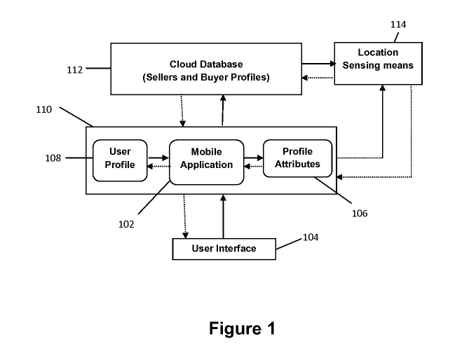

FIG. 1 is a schematic representation of a system for location based targeted marketing in accordance with an embodiment of the present invention. Referring to FIG. 1, the system comprises a mobile application 102 that facilitates the matching of sellers with a potential buyer in a targeted marketing environment. The mobile application 102 is installed in a mobile device 110, such as a smart phone, iPhone, iPad, iTab etc. The user with the mobile device 110 moves from one place to other and thus the mobile application 102. The mobile application 102 is viewable by the user through a user interface 104 on the mobile device. The user can feed their input to the mobile application 102 using input means such as keypad, using the user interface 104.

During the first time use of the mobile application 102, the user is prompted to sign up for the mobile application 102. The mobile application 102 can be installed on the mobile device 110. For sign-up user has to provide the personal details and login details for registration. After successful registration of the user on the mobile application 102, the user is required to login the mobile application 102 each time the user wishes to enter his preferences. The mobile application 102 can be provided with high level security features that include but are not limited to passwords, security questions, one time password etc. A user profile 108 is created in the mobile application 102 that contains the user's details. The user profile 108 among other includes name, address, phone number, email details etc. For accessing the user profile, the user has to enter his or her login credentials.

After logging in, the mobile application 102 provides option to the user for adding his or her preferences. These options include user preferences, acting as a buyer, acting as a seller, posting a requirement for buying a product, posting a requirement for selling a product, and for successful sign-out from the mobile application 102. Depending upon the user requirement, the user input the preferences for buying or selling a product or a service that acts as advertisement for offer. The user that offers a product or service for sale is the seller and the user that posts the requirement for buying a product or service is the buyer.

The information in the user profiles 108 and the preferences are stored as a profile attributes 106 in the mobile device 110 and the cloud database 112. The profile attributes 106 comprise information on the profile information such as user id, password, status, user type etc. The profile attributes 106 comprise the buyer criteria, seller criteria, product details, service details, payment mode and details etc.

The user profile 108 and the profile attributes 106 are stored in a cloud database 112 accessible through internet. The cloud database 112 gets continuously updated by collecting the information from all the mobile devices that are having the mobile application 102. The mobile devices having the mobile application 102 are in connection with the cloud database 112 having the user profile 108 and preferences of the entire user.

The mobile device further comprises of a location sensing means 114 that track the current location of the mobile device. The location sensing means 114 can be a GPS system integrated in the mobile device. In another aspect the mobile device 110 is equipped with a communication means such as a radio wave that receives the location coordinates from the GPS system installed in the vicinity. Alternatively the mobile device 110 can track the location using the internet.

The location sensing means 114 detects the local coordinates of the mobile device 110 and communicates the location to the mobile application 102. The mobile application 102 tracks other mobile devices 110 having the mobile application 102 that are in the range of the local coordinates. The mobile application 102 then matches the user preferences with the preferences of other users that are present in the range of the user and if the user preference matches with the preference of other user, the mobile application 102 then notifies the user about availability of the products or services.

For instance, if the user wishes to buy a product with certain parameters, then the user feeds the parameters in the mobile application 102 in the mobile device 110. As the user moves with the mobile device, the mobile application 102 tracks the location of the mobile device 110 and coordinates with the cloud database 112 to find the other mobile devices having the mobile application 102 configured in it. The mobile application 102 screens the available mobile devices for the product details and if a mobile device is having an advertisement for sale of the product having the same parameters, then the mobile application notifies the user of the available product.

In an embodiment of the present invention, the notification by the mobile device is in form of alert, message, vibration, LED light simulation etc.

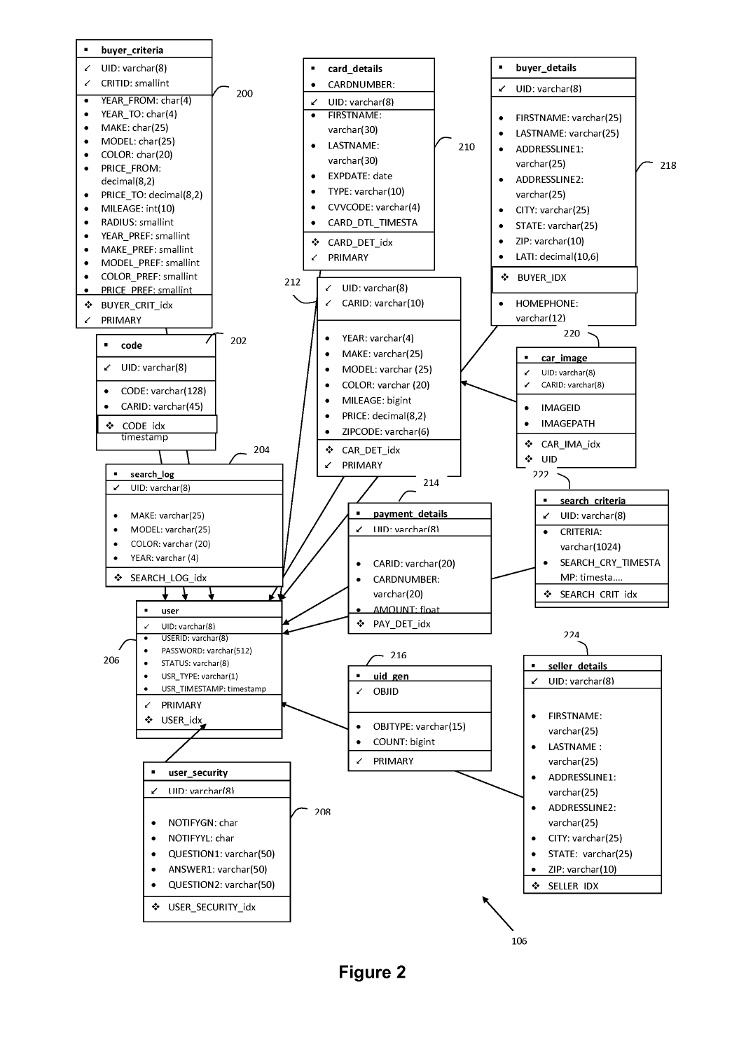

FIG. 2 illustrates a functional architecture of a mobile application used for location based targeted marketing in accordance with an embodiment of the present invention. The mobile application stores various attributes for effectively matching buyer criteria with the seller product parameters in a geographical area. Referring to FIG. 2, the profile attributes 106 stored in the mobile application 102 comprise user profile 206, user security 208, buyer criteria 200, product code 202, search log 204, card details 210, payment details 214, product details 212, product image 220, buyer details 218, search criteria 222, seller details 224 etc.

The user profile contains attributes 206 such as user id, password, status, user type, user timestamp etc. Since the mobile application 102 is provided with security features having login details with user id and password, the user id is a variable character chosen by the user while signing up for the mobile application 102. During the sign up process the mobile application 102 looks for the availability of user id and if the chosen user id has not been taken already then that user id is assigned to the user and the attributes are stored in the cloud database 112. Each user has a unique user id and no two users can have the same user id for the mobile application 102.

The user id is protected with a password and attributes are stored in the user id attributes. The user profile 206 also includes the status of the user and the attributes are stored in user profile attributes. The type of user is also stored as user profile attributes. The information on the type of user is critical from the point of view of buyer or seller. The user can be an individual, a legal entity, a government agency, a consumer, a service provider, a professional, a dealer, a commission agent, a supplier or a business entity. The user type attributes can be used to target a specific type of user.

The user profile 206 is protected with another level of security feature i.e. user security 208 that helps in the identification of the user in the event of forgetting password or logging in other mobile device. The attributes for security features are stored as user security attributes 208. The security features among other include multiple security questions and their answers provided by the user. The answers to these security questions are known to the user only and hence can be used to identify the user.

The user if interested in buying a product or a service can provide his details to the mobile application 102, such that in the event of matching product or service as per the user's preferences, the seller may contact the buyer. The details of the user are stored as buyer details attributes 218. The buyer details attributes 218 include the first name and last name of the buyer, address line 1, address line 2, city, state, latitude, longitude, country, buyer's mobile no, phone no., email details and timestamp information. The attributes are variable characters and can range from 2 to 50 characters.

The mobile application 102 requires the user or buyer to enter his or her requirement for a product or a service. The user specifies his criteria for searching the product or service. These criteria are stored as buyer criteria attributes 200 in the mobile application 102. The buyer criteria vary from product to product and service to service. For instance if a user is interested in buying a car then the buyer criteria includes range of manufacturing year, make of the car, model of the car, color, price range, mileage, turning radius, preferred manufacturing year, preferred make, preferred model, preferred price, mileage preference and turning radius preference etc.

Alternatively if the user wishes to buy a laptop, then the buyer criteria attributes include the make, model, manufacturer, type of operating system, type of RAM and capacity, screen size, multimedia feature and price range etc.

Based on the buyer criteria entered by the user, the mobile application searches for the available products or services for the relevant match. If a relevant match is found in the geographical area, then the search results are displayed on the user interface 104 of the mobile device. The search log is stored as search log attributes 204 in the mobile application showing the searches performed by the user.

While the user moves from one place to another, the mobile application 102 searches a match for buyer criteria in that geographical location and presents the matches to the buyer. The buyer can select a product from the available results and can make a direct payment to the seller. The payment can be made through wire transfer, credit card or debit card. The mobile application 102 stores the payment attributes 214 for the payment method chosen by the buyer, thus eliminating the need of entering the details again and again.

In another embodiment of the invention the user of the mobile application 102 may be interested in selling a product or in offering a service. The mobile application 102 requires the seller to enter his details and stores the details as seller attributes 224. The seller attributes 224 include first name and last name of the seller, address line 1, address line 2, city, state, zip, latitude and longitude information, country, phone details and email details etc. The seller then adds the details of the product or the service that he wants to offer. The details of the product or the service among others include the attributes such as make, model, price, year, color, mileage (in case the product is an automobile) and the specification of the product or the service. The seller can also upload an image of the product and the image is stored as the product image attributes 220. The seller can also provide the details of the payment that are stored as payment detail attributes 214.

In an embodiment of the present invention the user of the mobile application 102 can be a seller offering a product or a service, or can be a buyer in requirement of a product or a service.

In another embodiment of the present invention the single mobile application 102 can be used to post multiple requirements. For instance, the user can enter buying requirement for a vehicle, a mobile phone, a laptop, a camera or a service using the same mobile application 102. Simultaneously user can post the for-sale advertisement for other product or service. This implies that mobile application 102 is not limited to a particular number of advertisements that the user may post.

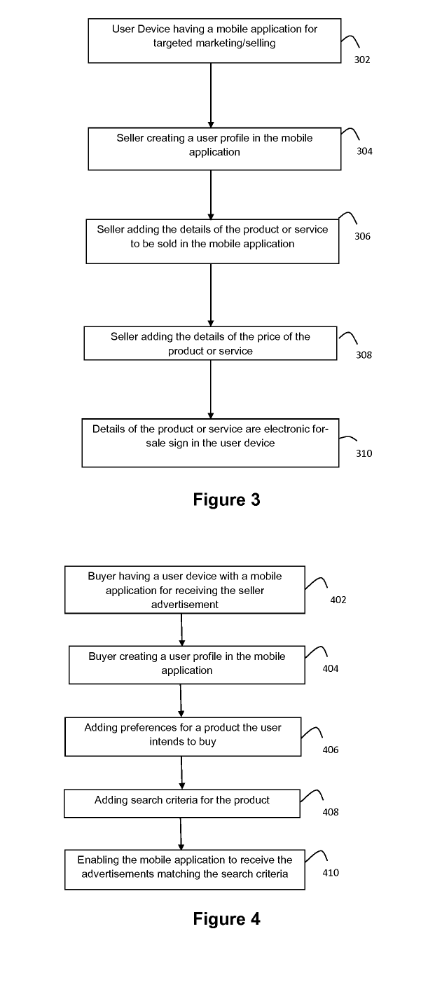

FIG. 3 is a flow diagram explaining the process of advertising a product for sale by a user, using the mobile application in accordance with an embodiment of the present invention.

Referring to FIG. 3, the flow diagram illustrates a detailed example of advertising a product to be sold by a user using the mobile application 102 in a mobile device 110, such as a smart phone. First step 302 depicts one such user who is interested to advertise/market/sell a product or a service to targeted buyer segments.

In the next step 304, the mobile application 102 facilitates the user to create a profile as a seller of product or service. The user profile 108 is generated when the user registers his personal details in the mobile application 102 such as name, complete address, contact numbers and area code etc., creating a User ID and password to access his profile. The user would receive a confirmation or acknowledgement after the completion of the registration process, and can Log-in using the User ID and Password subsequently.

Once the profile is created, the seller, who can be a dealer, wholesaler, manufacturer or an individual, can add the details of the product or service that is to be sold in the next step 306. The details for instance, of a car to be sold, can be the car's year of manufacture, make, model number, mileage etc. Once the car's details are added by the seller, the details are saved by the mobile application 102 in the cloud database 112. These details would be accessed by users of other mobile devices in the same geographical area, who have the mobile application 102 configured to their mobile devices and are interested to get informed about a car with similar details.

Next step for the seller is to add the price on which the product or service is intended to be sold and the mode of payment is decided 308.

This complete process of adding and saving details of the product or service generates an electronic for-sale sign in the mobile device, in step 310. The electronic for-sale sign is tracked by Global Positioning System tracker and is advertised to the target customers.

FIG. 4 is a flow diagram illustrating the process of advertising requirement of a product, using the mobile application in accordance with an embodiment of the present invention. Referring to FIG. 4, the flow diagram illustrates a detailed example, wherein the mobile application 102 enables a user having a mobile device 110, such as a smart phone, to receive advertisements for a product or service. In the beginning of the process 402, a user who is interested to be notified about an advertisement for a product or service, configures the mobile application 102 in the mobile device 110 such as a smart phone.

In the next step 404, the buyer creates a user profile 108 in the mobile application 102 by filling personal details. The details include name, complete address, area code, contact numbers etc. A User ID and password are added that are to be entered on every Log-in activity, once there is a successful registration.

With the user profile 108 the user has a choice to add preferences for a product or a service as per choice. These preferences details are saved by the mobile application 102 in the next step 406. For instance, a user may be interested in buying a watch. The mobile application 102 enables the user to enter his preferences for a watch, like brand, type such as analog watch or digital watch and color of the watch etc.

In the next step 408, the buyer would select search criteria for a product or service (watch). The buyer may set criteria for limiting the maximum price of the watch or the year of manufacture. Further, the buyer can set restrictions regarding location of a watch seller within a certain radius. This additional detail would get saved in the buyer's profile.

The mobile application 102 would screen advertisements for watches in the cloud database 112 in that particular geographical area through location based searching and tracking, as per the buyer's preferences and criteria. The last step 410 would provide the buyer with all the relevant advertisements that have a match with the buyer's criteria 200. The buyer would receive notifications or messages as per the search string carried out in the mobile application 102.

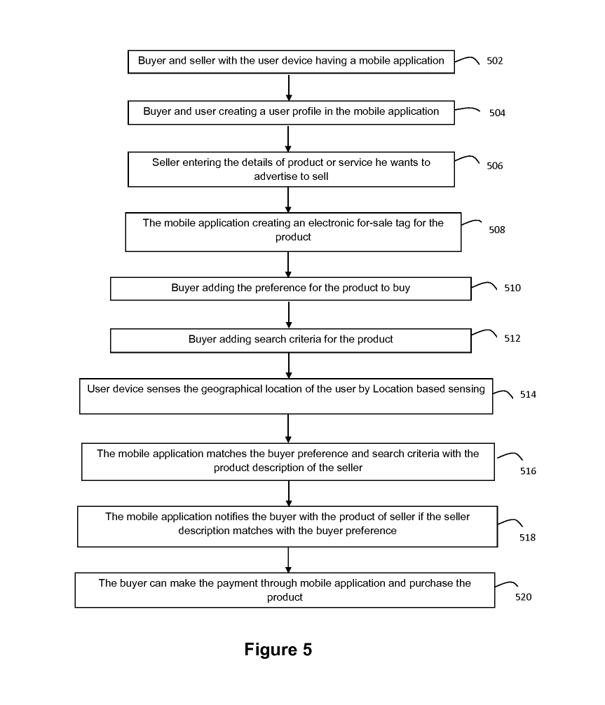

FIG. 5 is a flow diagram that illustrates the operation for facilitating the match between the buyer and the seller criteria in accordance with an embodiment of the present invention. Referring to FIG. 5 a flowchart showing the method for depicting a suitable match between buyer and seller of a product or a service, both having the mobile application 102 in their mobile devices 110, such as smart phones.

The first step 502 depicts a buyer of a product or service and a seller of a product and service having the mobile application 102 installed and configured on their respective mobile devices 110.

The next step 504 explains that both buyer and the seller create user profiles 108 by entering their respective personal details in the mobile application 102. These details get saved and available in the cloud database 112. Each of them can access their user profiles 108 to perform mobile commerce.

The seller can enter the details of a product or service intended to be sold. The seller may advertise or market for the product or service through the mobile application, as per step 506.

In subsequent step 508 the mobile application 102 would generate a unique electronic for-sale sign/tag for the product or service. For instance, the product is a mobile phone. The mobile application 102 creates an advertisement that will be available online for the specific mobile phone. The electronic for-sale sign would link the generated advertisement with a person's user profile.

On the other hand, as per step 510, buyer would add preferences for the product or service he intends to buy. In case the buyer is also interested to buy a mobile phone, he would enter preferences like brand name, model number and color etc. The buyer would next select certain criteria for the mobile application 102 to search for the advertisements of the mobile phone. The criteria can be price range, additional phone features or the location of sellers within a radius as described in step 512.

In next step 514, the geographical location of the electronic for-sale sign of seller and that of the buyer's device would be tracked by Global Positioning System. If both seller and buyer are within a defined radius, as per the criteria chosen by them, and fall in the reach of each other's network, the messages or advertisements of the electronic for-sale sign would reach the mobile device of the buyer, so that the buyer and the seller are able to see each other's user profile.

In next step 516, if the preferences and criteria specified by the buyer overlap with the specifications of seller's product or service, the mobile application 102 would identify a potential match between the buyer and the seller. Similarly, if there are more watch sellers in that geographical area with similar match would also be selected. The mobile application 102 would screen the most relevant of the matches as per the buyer's preferences and criteria and prepare a listing of the watch advertisements of various sellers.

In step 518, the mobile application 102 prepares a notification or a message and contacts the buyer. The notification or message comprises the specifications of the products matched with buyer's requirements. There will be an order of the product listing, wherein the product having the highest relevancy to the buyer's search criteria will top the listing, those having some similarity in their features specification with that of buyer's criteria, would show later and finally those having lowest relevancy would show last in the listing of search results.

In the last step 520, the buyer can select the product that is the closest match among all and can proceed further to make payments. The mobile application 102 provides a medium for online transactions.

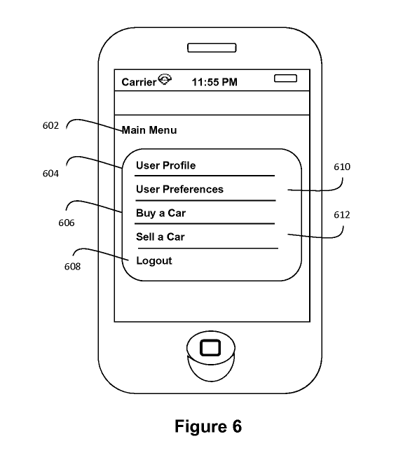

FIG. 6 shows a user interface 104 showing the options available for a buyer or a seller in the mobile application 102 in accordance with an embodiment of the present invention. The mobile application 102 offers several options to buyers and sellers to enhance mobile commerce. The graphical interface is user-friendly that is easy to operate and presents a guided approach. Once User ID and password are generated and user profiles 108 are created, the users (buyers or sellers) can navigate through the main page of the interface to proceed further.

The “Main Menu” 602 provides various links to the user. First link is a “User Profile” 604 with the details of the user. Personal details can be edited in course of time. Next link is “User Preference” 610, wherein the user's choices for cars can be represented. There can be different categories to select from, such as, size of a car (luxury, SUV, medium, small). Next there can be preference to price range in a particular category; new car or used car; model number, mileage of the car, location of the car seller up to a particular radius etc.

For a seller, preferences may include a specific price range, within which the seller wants to sell the car, maximum radius up to which the buyer may be present and payment receiving options etc.

Third link of the menu is “Buy a Car” 606, wherein upon clicking the user can get access to advertisements of cars that are present in the geographical area of the user, and can identify a car of choice. The mobile application 102 would present the list of cars starting from the most suitable match for the buyer.

Fourth link in the menu is “Sell a Car” 612 that can enable users to identify potential buyer(s) for cars and target them to advertise/market their car for selling.

The mobile application 102 allows the users to go back to the previous menu. The last link 608 allows a user to log out of the mobile interface.

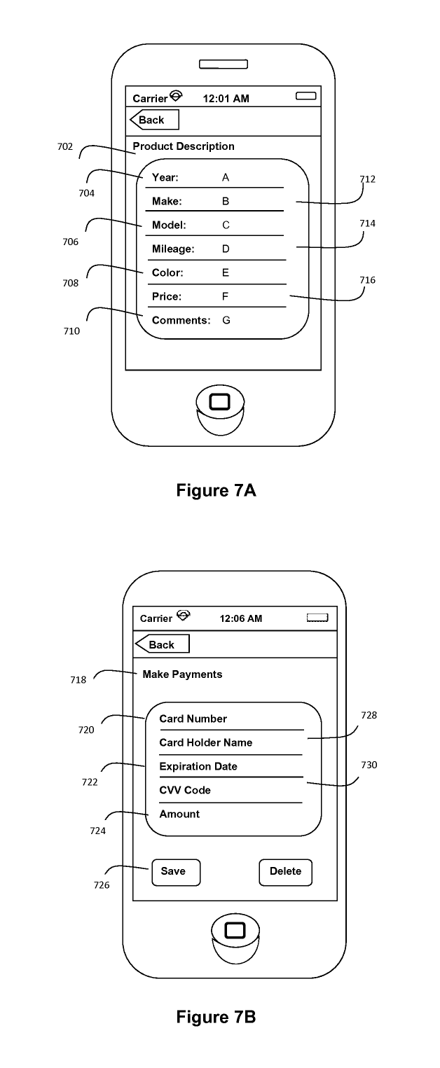

FIGS. 7A and 7B show a user interface 104 with the “Product or Service Description” offered by the seller and the payment information in accordance with an embodiment of the present invention. FIG. 7A depicts the product description 702 page of the interface after the mobile application 102 has run various search strings to search, identify and locate the car matching with a buyer's specifications and criteria.

For a particular car, selected by the buyer from the search results, a car's year of manufacture 704, make of the car 712, model number of the car 706, mileage of the car 714, car color 708 and car price 716 are depicted. If the seller has given any additional details of the car with respect to performance, that is shown in the link to comments 710.

FIG. 7B illustrates “Make Payments” 718 section that provides a platform for carrying out transactions between car buyers and car sellers. The buyer can enter the debit/credit card number 720 in the interface. In the next step, the buyer would enter the complete name 728 as registered for the card. Next, the buyer would enter the expiration date of the card 722 and the CVV code 730 present on the card.

Finally the buyer would enter the amount 724 to be paid. The buyer can save 726 the details and proceed further. The amount 724 would be transacted by the mobile application interface from the buyer's account.

The mobile application 102 allows the users to go back to the previous menu anytime before the transaction is initiated.

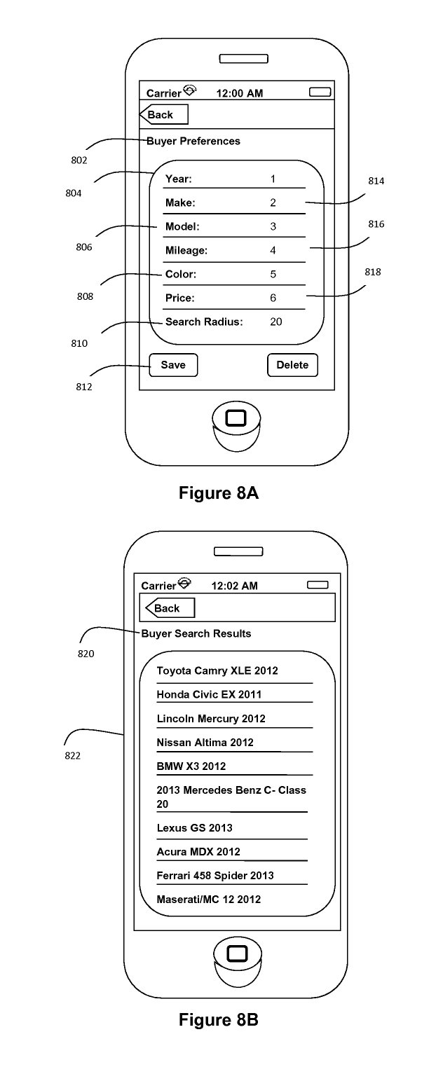

FIGS. 8A and 8B show a user interface 104 of the mobile application showing the buyer preference criteria 802 and the corresponding search result displayed by the mobile application in accordance with an embodiment of the present invention.

FIG. 8A illustrates “Buyer Preferences” 802 according to Year of the car manufacture 804, Make of the car 814, Model number 806, Mileage 816, Car Color 808, Price 818 and the Search Radius 810 (radius within which the buyer would be available).

The buyer can add, edit and delete the preferences. Saving the details would lead the buyer to the next step.

FIG. 8B illustrates the interface showing “Buyer Search Results” 820. The mobile application 102 sends a search query to the cloud database 112 and brings out search results 820 for cars in nearby geographical area as per the buyer's preferences and criteria. The car listing 822 shows a list of cars that may pose as a potential match to the buyer's preferences. The cars listed on the top/front page would be the most relevant among all the screened results.

We claim:

1. A method for facilitating the advertisement of an offer for sale to targeted consumer segments comprising:
providing an application configured in a mobile device wherein the user of the mobile device can create a user profile to advertise the offer for sale or a buying requirement;
entering the details of the offer for sale by the seller and a criteria for the buying requirement in the application configured in the mobile device;
storing the attributes for user profile, details of the offer for sale and the criteria for buying requirement in a cloud database;
tracking the geographical location of the mobile device using location sensing means and determining the coordinates of the mobile device;
searching for available mobile device with the application in the determined coordinates and screening the available mobile devices for offer for sale or the buying requirement;
establishing a match between the buying requirement and details of offer for sale in the available mobile devices with the user device;
notifying the user in the event of a match between the buying requirement of the user device and the details of offer for sale of the available mobile device in the determined coordinates.

2. The method of claim 1 wherein the offer for sale is for a physical product or an offer for service.

3. The method of claim 1 wherein the user profile is protected with security features.

4. The method of claim 1 wherein the advertisement comprises buying a product, selling a product, an offer for a service and a requirement for a service.

5. The method of claim 1 wherein the location sensing means comprises a GPS device adaptable to receive coordinates from the GPS device positioned in the geographical area.

6. The method of claim 1 wherein the notification is in form of alert, message, vibration or LED light simulation.

7. The method of claim 1 wherein the attributes comprise user profile, user security, buyer criteria, product code, search log, card details, payment details, product details, product image, buyer details, search criteria and seller details etc.

8. The method of claim 1 wherein the application interacts with the cloud database to search for available mobile devices in the determined coordinates.

9. The method of claim 1 wherein the application screens for a match between the buying criteria of the buyer with the details of offer of sale.

10. A system for notifying a buyer with a list of available products that are of interest to the buyer comprising:
a mobile device having an application configured to enable a user to create a profile and to enter the details of the product to create an advertisement, wherein if the user is a buyer, the details are for buying preferences and if the user is a seller the details are the product description;
a first module in the mobile device to store the attributes for user profile and the buying preferences and the product description;
a cloud database to store the attributes of all the users using the application configured in the mobile devices, said cloud database interacts with the application through Internet;
a location sensing means in the mobile device to determine the local coordinates of the mobile device and sending the local coordinates to the cloud database;
wherein the said application interacts with cloud database to find the list of available application in the local coordinates and to establish a match between the buying preference of the buyer with the list of available product descriptions, and notifying the buyer in the event of a match.

11. The system of claim 10 wherein the products comprise physical product or a professional service.

12. The system of claim 10 wherein the profile is protected with security features.

13. The system of claim 10 wherein the product description comprises make, model, price, color and characteristic features of the product.

14. The system of claim 10 wherein the mobile device is a smart phone.

15. The system of claim 10 wherein the attributes comprise user profile, user security, buyer criteria, product code, search log, payment details, product details, product image, buyer details, search criteria, seller details.

16. The system of claim 10 wherein the location sensing means comprises a GPS.

17. The system of claim 10 wherein the notification is in the form of LED light simulation.

18. The system of claim 10 wherein the available product comprises the products advertized for sale by the seller that are in the local coordinates.
